(19) United States
(12) Patent Application Publication
(10) Pub. No.: US 2021/0354634 A1
(43) Pub. Date: Nov. 18, 2021

(54) ELECTRONIC DEVICE FOR VEHICLE AND METHOD OF OPERATING ELECTRONIC DEVICE FOR VEHICLE

(71) Applicant: LG ELECTRONICS INC., Seoul (KR)

(72) Inventors: Sangyol YOON, Seoul (KR); Hyeonju BAE, Seoul (KR); Taekyung LEE, Seoul (KR)

(73) Assignee: LG ELECTRONICS INC., Seoul (KR)

(21) Appl. No.: 16/500,801

(22) PCT Filed: Jan. 11, 2019
(86) PCT No.: PCT/KR2019/000463

§ 371 Date: Oct. 3, 2019

(51) Int. Cl. B60R 11/04; B60R 16/023; B60R 16/03; B60R 21/0134; G01S 13/86; G01S 13/931; G01S 17/931; G01S 15/931

(52) U.S. Cl. CPC B60R 11/04; B60R 16/023; B60R 16/03; G01S 15/931; G01S 13/867; G01S 13/931; G01S 17/931; B60R 21/0134

(57) ABSTRACT

Disclosed is an electronic device for a vehicle including a power supplier supplying power, and a processor acquiring data on an object outside a vehicle in the state in which the power is supplied thereto and determining a data processing region in the field of view (FOV) of at least one range sensor oriented toward the object based on the data on the object.

### TECHNICAL FIELD

The present disclosure relates to an electronic device for a vehicle and a method of operating an electronic device for a vehicle.

### BACKGROUND ART

A vehicle is an apparatus that carries a passenger in a direction intended by the passenger. A car is the main example of such a vehicle.

In order to increase the convenience of vehicle users, a vehicle is equipped with various sensors and electronic devices. In particular, an Advanced Driver Assistance System (ADAS) is under active study with the goal of increasing the driving convenience of users.

In order to realize an ADAS, at least one sensor and a processor are operated at all times in order to acquire data on objects outside a vehicle. Therefore, power for driving the sensor and the processor is required at all times. In addition, in order to continuously acquire data on objects outside the vehicle, the processor needs to perform a large amount of calculations. Moreover, in order to combine data generated by various sensors, a processor having a higher level of calculation ability and power for driving the same are required.

### DISCLOSURE

### Technical Problem

Therefore, the present disclosure has been made in view of the above problems, and it is an object of the present disclosure to provide an electronic device for a vehicle for reducing the amount of calculations when data on objects outside a vehicle is generated.

It is another object of the present disclosure to provide a method of operating an electronic device for a vehicle for reducing the amount of calculations when data on objects outside a vehicle is generated.

However, the objects to be accomplished by the disclosure are not limited to the above-mentioned objects, and other objects not mentioned herein will be clearly understood by those skilled in the art from the following description.

### Technical Solution

In accordance with the present disclosure, the above and other objects can be accomplished by the provision of an electronic device for a vehicle including a power supplier supplying power, and a processor acquiring data on an object outside a vehicle in the state in which the power is supplied thereto and determining a data processing region in the field of view (FOV) of at least one range sensor oriented toward the object based on the data on the object.

According to the embodiment of the present disclosure, the processor may generate a signal for setting at least one of the frame rate or the sensing range of the at least one range sensor that is oriented toward the object. According to the embodiment of the present disclosure, the electronic device may further include an interface unit for receiving data on the object from at least one of a communicator mounted in the vehicle or a camera mounted in the vehicle.

According to the embodiment of the present disclosure, the processor may receive first data on the object from an external device through the communicator mounted in the vehicle, may determine a first region, in which the probability that the object is located is equal to or greater than a predetermined value, based on the first data, and may determine the first region to be the data processing region.

According to the embodiment of the present disclosure, the processor may receive second data on the object from the camera mounted in the vehicle, may determine a second region, in which the probability that the object is located is equal to or greater than a predetermined value, based on the second data, and may determine the second region to be the data processing region.

According to the embodiment of the present disclosure, upon determining that the first data and the second data do not match each other, the processor may determine a region in which the first region and the second region are included to be the data processing region.

According to the embodiment of the present disclosure, the processor may acquire motion planning data of the vehicle and may determine the data processing region based further on the motion planning data.

Details of other embodiments are included in the detailed description and the accompanying drawings.

### Advantageous Effects

According to the present disclosure, there are one or more effects as follows.

First, a sensing parameter of a range sensor may be set based on data on an object, and thus a calculation load may be reduced during algorithm operation.

Second, power consumption may be reduced due to the reduction in the calculation load.

However, the effects achievable through the disclosure are not limited to the above-mentioned effects, and other effects not mentioned herein will be clearly understood by those skilled in the art from the appended claims.

### DESCRIPTION OF DRAWINGS

FIG. 1 is a view illustrating the external appearance of a vehicle according to an embodiment of the present disclosure.

FIG. 2 is a view for explaining objects according to the embodiment of the present disclosure.

FIG. 3 is a block diagram for explaining a vehicle and an electronic device for a vehicle according to the embodiment of the present disclosure.

FIG. 4 is a block diagram for explaining the electronic device for a vehicle according to the embodiment of the present disclosure.

FIG. 5a is a flowchart of the electronic device for a vehicle according to the embodiment of the present disclosure.

FIG. 5b is a flowchart of a detailed algorithm of step S530 in FIG. 5a.

FIG. 6 is a view for explaining the operation of the electronic device for a vehicle according to the embodiment of the present disclosure.

FIG. 7 is a flowchart of the electronic device for a vehicle according to the embodiment of the present disclosure.

FIGS. 8 and 9 are views for explaining the operation of the electronic device for a vehicle according to the embodiment of the present disclosure.

FIG. 10 is a flowchart of the electronic device for a vehicle according to the embodiment of the present disclosure.

FIG. 11 is a view for explaining the operation of the electronic device for a vehicle according to the embodiment of the present disclosure.

### BEST MODE

Reference will now be made in detail to the preferred embodiments of the present disclosure, examples of which are illustrated in the accompanying drawings. Wherever possible, the same reference numbers will be used throughout the drawings to refer to the same or like parts. As used herein, the suffixes “module” and “unit” are added or interchangeably used to facilitate preparation of this specification and are not intended to suggest unique meanings or functions. In describing embodiments disclosed in this specification, a detailed description of relevant well-known technologies may not be given in order not to obscure the subject matter of the present disclosure. In addition, the accompanying drawings are merely intended to facilitate understanding of the embodiments disclosed in this specification and not to restrict the technical spirit of the present disclosure. In addition, the accompanying drawings should be understood as covering all equivalents or substitutions within the scope of the present disclosure.

Terms including ordinal numbers such as first, second, etc. may be used to explain various elements. However, it will be appreciated that the elements are not limited to such terms. These terms are merely used to distinguish one element from another.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

The expression of singularity includes a plural meaning unless the singularity expression is explicitly different in context.

It will be further understood that terms such as “include” or “have”, when used in this specification, specify the presence of stated features, integers, steps, operations, elements, components, or combinations thereof, but do not preclude the presence or addition of one or more other features, integers, steps, operations, elements, components, or combinations thereof.

In the description below, the left side of the vehicle means the left side with respect to the direction of travel of the vehicle and the right side of the vehicle means the right side with respect to the direction of travel of the vehicle.

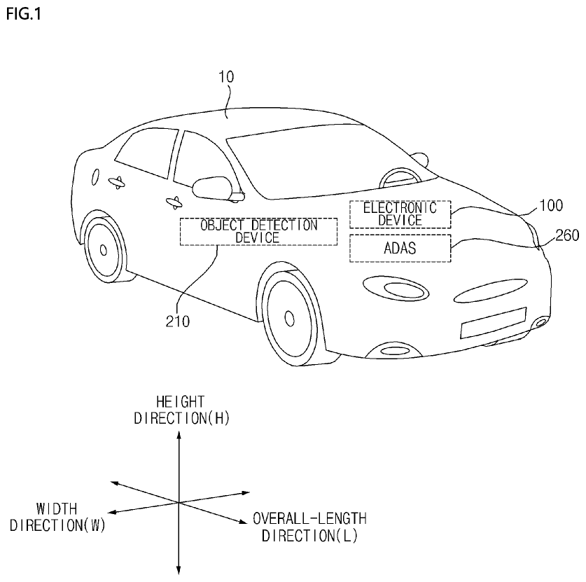

FIG. 1 is a view illustrating the external appearance of a vehicle according to an embodiment of the present disclosure.

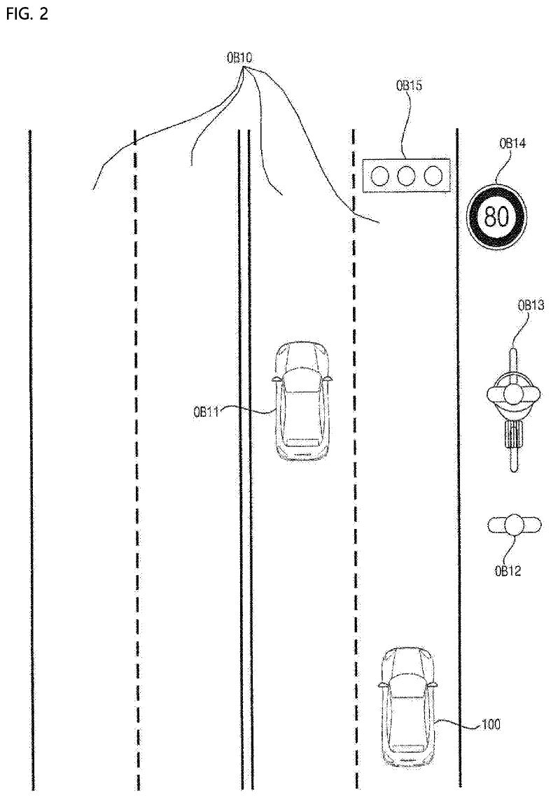

FIG. 2 is a view for explaining objects according to the embodiment of the present disclosure.

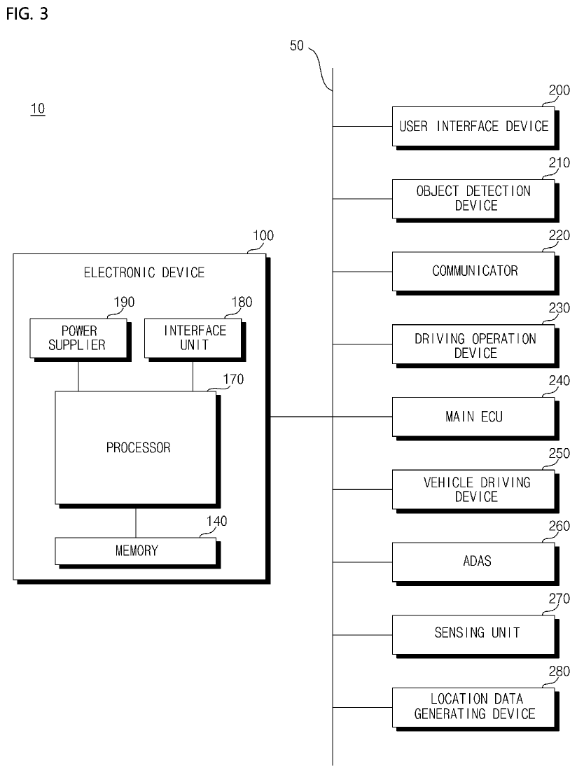

FIG. 3 is a block diagram for explaining a vehicle and an electronic device for a vehicle according to the embodiment of the present disclosure.

Referring to FIGS. 1 to 3, a vehicle 10 according to an embodiment of the present disclosure is defined as a transportation means that travels on a road or on rails. The vehicle 10 conceptually encompasses cars, trains, and motorcycles. The vehicle 10 may be any of an internal combustion vehicle equipped with an engine as a power source, a hybrid vehicle equipped with an engine and an electric motor as power sources, an electric vehicle equipped with an electric motor as a power source, and the like.

The vehicle 10 may include a vehicle electronic device 100. The vehicle electronic device 100 may be mounted in the vehicle 10. The vehicle electronic device 100 may set a sensing parameter of at least one range sensor based on the acquired data on objects.

In order to realize an Advanced Driver Assistance System (ADAS) 260, an object detection device 210 acquires data on objects outside the vehicle 10. The data on objects may include at least one of data on the presence or absence of an object, data on the location of an object, data on the distance between the vehicle 10 and an object, or data on the relative speed of the vehicle 10 with respect to an object.

The object may be any of various items related to driving of the vehicle 10.

As illustrated in FIG. 2, objects O may include lanes OB10, another vehicle OB11, a pedestrian OB12, a 2-wheeled vehicle OB13, traffic signals OB14 and OB15, a light, a road, a structure, a speed bump, a geographic feature, an animal, and so on.

The lanes OB10 may include a traveling lane, a lane next to the traveling lane, and a lane in which an oncoming vehicle is traveling. The lanes OB10 may conceptually include left and right lines that define each of the lanes. The lanes may conceptually include a crossroad.

Another vehicle OB11 may be a vehicle traveling in the vicinity of the vehicle 10. Another vehicle may be a vehicle located within a predetermined distance from the vehicle 10. For example, another vehicle OB11 may be a vehicle that precedes or follows the vehicle 10.

The pedestrian OB12 may be a person located in the vicinity of the vehicle 100. The pedestrian OB12 may be a person located within a predetermined distance from the vehicle 10. For example, the pedestrian OB12 may be a person on a sidewalk or a roadway.

The 2-wheeled vehicle OB13 may refer to a transportation means moving on two wheels around the vehicle 10. The 2-wheeled vehicle OB13 may be a transportation means having two wheels, located within a predetermined distance from the vehicle 10. For example, the 2-wheeled vehicle OB13 may be a motorcycle or bicycle on a sidewalk or a roadway.

The traffic signals may include a traffic light device OB15, a traffic sign OB14, and a symbol or text drawn or written on a road surface. The light may be light generated by a lamp of another vehicle. The light may be light generated by a street lamp. The light may be sunlight. The road may include a road surface, a curved road, an inclined road such as an uphill or downhill road, and so on. The structure may be an object fixed on the ground near a road. For example, the structure may include a street lamp, a street tree, a building, a telephone pole, a traffic light device, a bridge, a curb, a wall, and so on. The geographic feature may include a mountain, a hill, and so on.

Objects may be classified into mobile objects and fixed objects. For example, mobile objects may conceptually include another vehicle that is traveling and a pedestrian who is moving. For example, fixed objects may conceptually include a traffic signal, a road, a structure, another vehicle that is not moving, and a pedestrian who is not moving.

The vehicle 10 may include a vehicle electronic device 100, a user interface device 200, an object detection device 210, a communicator 220, a driving operation device 230, a main ECU 240, a vehicle driving device 250, an ADAS 260, a sensing unit 270, and a location data generating device 280.

The electronic device 100 may acquire data on an object OB outside the vehicle 10, and may generate a signal for setting a sensing parameter of a range sensor based on the data on the object. The electronic device 100 may include an interface unit 180, a power supplier 190, a memory 140, and a processor 170.

The interface unit 180 may exchange signals with at least one electronic device provided in the vehicle 10 in a wired or wireless manner. The interface unit 180 may exchange signals with at least one of the user interface device 200, the object detection device 210, the communicator 220, the driving operation device 230, the main ECU 240, the vehicle driving device 250, the ADAS 260, the sensing unit 270, or the location data generating device 280 in a wired or wireless manner. The interface unit 180 may be configured as at least one of a communication module, a terminal, a pin, a cable, a port, a circuit, an element, or a device.

The interface unit 180 may receive data on objects OB10, OB11, OB12, OB13, OB14 and OB15 outside the vehicle 10 from the communicator 220 mounted in the vehicle 10. The interface unit 180 may receive data on objects outside the vehicle 10 from the camera mounted in the vehicle 10.

The power supplier 190 may supply power to the electronic device 100. The power supplier 190 may receive power from a power source (e.g. a battery) included in the vehicle 10, and may supply the power to each unit of the electronic device 100. The power supplier 190 may operate in response to a control signal from the main ECU 240. The power supplier 190 may be implemented as a switched-mode power supply (SMPS).

The memory 140 is electrically connected to the processor 170. The memory 140 may store basic data for a unit, control data for controlling the operation of the unit, and input and output data. The memory 140 may store data processed by the processor 170. The memory 140 may be implemented as at least one hardware device selected from among Read-Only Memory (ROM), Random Access Memory (RAM), Erasable and Programmable ROM (EPROM), a flash drive, and a hard drive. The memory 140 may store various data for the overall operation of the electronic device 100, such as programs for processing or control in the processor 170. The memory 140 may be integrated with the processor 170. In some embodiments, the memory 140 may be configured as a lower-level component of the processor 170.

The processor 170 may be electrically connected to the interface unit 180 and the power supplier 190, and may exchange signals with the same. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for performing other functions.

The processor 170 may be driven by the power supplied from the power supplier 190. The processor 170 may receive data, process data, generate a signal, and provide a signal while receiving the power from the power supplier 190.

The processor 170 may acquire data on objects outside the vehicle 10 in the state in which power is supplied thereto.

The processor 170 may acquire data on the objects OB10, OB11, OB12, OB13, OB14 and OB15 from the communicator 220 mounted in the vehicle 10 through the interface unit 180 in the state in which power is supplied thereto. The processor 170 may receive first data on objects from an external device through the communicator 220. The communicator 220 may receive data on objects from an external device outside the vehicle 10 through V2X communication. The external device may be at least one of another vehicle or a server. Another vehicle may detect objects and may generate data on the objects based on a sensor (e.g. a camera, a radar, a lidar, an ultrasonic sensor, an infrared sensor, etc.). The data generated in another vehicle may be directly transmitted to the vehicle 10, or may be transmitted to the vehicle 10 via a server.

The processor 170 may receive data on objects from at least one of the cameras mounted in the vehicle 10 through the interface unit 180 in the state in which power is supplied thereto. The processor 170 may receive second data on objects from the camera. The camera may be configured as a lower-level component of the object detection device 210. The camera may acquire at least one of a front image, a rear image, or a side image of the vehicle 10, may detect objects in the image, and may generate data on the objects.

The processor 170 may generate a signal for setting the sensing parameter of at least one range sensor based on data on objects in the state in which power is supplied thereto. The range sensor may be understood to be a sensor that generates data on objects using at least one of a Time-of-Flight (ToF) scheme, a structured light scheme, or a disparity scheme. The range sensor may include at least one of a radar, a lidar, an ultrasonic sensor, or an infrared sensor, which is included in the object detection device 210.

The processor 170 may provide a signal to the object detection device 210 so that at least one range sensor senses objects.

The processor 170 may generate a signal for setting the frame rate of at least one range sensor that is oriented toward objects. For example, the processor 170 may increase the frame rate based on data on objects. More accurate data on the objects may be generated by increasing the frame rate. For example, the processor 170 may generate a signal for increasing the frame rate of a signal (e.g. electromagnetic radiation, laser radiation, ultrasonic radiation, infrared radiation, etc.) emitted from at least one range sensor toward objects based on data on objects.

The processor 170 may provide a signal for setting the sensing range of at least one range sensor that is oriented toward objects. For example, the processor 170 may increase the sensing range based on data on objects. More accurate data on the objects may be generated by increasing the sensing range. For example, the processor 170 may generate a signal for increasing the sensing range of a signal (e.g. electromagnetic radiation, laser radiation, ultrasonic radiation, infrared radiation, etc.) emitted from at least one range sensor toward objects based on data on objects. For example, the processor 170 may generate a signal for changing the sensing range of a signal (e.g. electromagnetic radiation, laser radiation, ultrasonic radiation, infrared radiation, etc.) emitted from at least one range sensor toward objects based on data on objects.

The processor 170 may determine a data processing region in the field of view (FOV) of at least one range sensor that is oriented toward objects based on data on the objects. The processor 170 may determine a region in the FOV of the range sensor, in which objects are more likely to be located, to be a data processing region. The processor 170 may reduce a load of data processing by processing only data corresponding to the determined data processing region.

The processor 170 may determine a first region, in which the probability that an object is located is equal to or greater than a predetermined value, based on first data on the object received from an external device through the communicator 220. The first data may include information about the presence or absence of the object, information about the location of the object, and information about the type of the object. For example, a plurality of other vehicles may respectively generate data on a specific object, and may transmit the data to the vehicle 10 through V2X communication. The processor 170 may process the data, which is received from the other vehicles and includes location information of the object, and may determine a first region based on the data. The processor 170 may determine the first region to be a data processing region.

The processor 170 may determine a second region, in which the probability that an object is located is equal to or greater than a predetermined value, based on second data on the object received from the camera mounted in the vehicle 10. The second data may include information about the presence or absence of the object, information about the location of the object, information about the type of the object, and information about the distance between the vehicle 10 and the object. For example, the processor 170 may process the data, which includes location information of the object and information about the distance between the vehicle 10 and the object, and may determine a second region based on the data. The processor 170 may determine the second region to be a data processing region.

The processor 170 may provide the generated signal to the object detection device 210. The object detection device 210 may control at least one range sensor based on a signal received from the electronic device 100.

The processor 170 may determine whether the first data and the second data match each other. For example, the processor 170 may determine whether the first data and the second data match each other based on whether the types of the objects match each other. For example, the processor 170 may determine that the first data and the second data match each other when the size of an error between the first data and the second data, each of which indicates the distance between the vehicle 10 and the object, is within a reference range. For example, the processor 170 may determine whether the first data and the second data match each other based on the object location data in the map data.

Upon determining that the first data and the second data do not match each other, the processor 170 may generate a signal for setting the sensing parameter of at least one range sensor. Upon determining that the first data and the second data do not match each other, the processor 170 may generate a signal for setting at least one of the frame rate or the sensing range of at least one range sensor that is oriented toward the object. Upon determining that the first data and the second data do not match each other, the processor 170 may determine a region that includes both the first region and the second region to be a data processing region.

The processor 170 may acquire third data on the object, which is generated based on the set sensing parameter, from the range sensor. The processor 170 may generate fusion data based on the first data on the object acquired from the communicator 220, the second data on the object acquired from the camera, and the third data acquired from the range sensor. The processor 170 may combine two or more of the first data, the second data, and the third data.

The processor 170 may acquire motion planning data of the vehicle 10. For example, the processor 170 may acquire motion planning data of the vehicle 10 from the main ECU 240 through the interface unit 180. The motion planning data may include at least one of data on the direction in which the vehicle 10 is to move, data on the distance that the vehicle 10 is to move, or data on the speed at which the vehicle 10 is to move. The processor 170 may generate a signal for setting the sensing parameter of at least one range sensor based further on the motion planning data of the vehicle 10. The processor 170 may generate a signal for setting at least one of the frame rate or the sensing range of at least one range sensor that is oriented toward the object based further on the motion planning data of the vehicle 10. The processor 170 may determine a data processing region in the field of view (FOV) of at least one range sensor that is oriented toward the object based further on the motion planning data of the vehicle 10. When the vehicle 10 moves, the object moves relative to the vehicle 10. The processor 170 may determine the data processing region more accurately based on the motion planning data and the data on the object.

The electronic device 100 may include at least one printed circuit board (PCB). The interface unit 180, the power supplier 190, the memory 140, and the processor 170 may be electrically connected to the printed circuit board.

The user interface device 200 is a device used to enable the vehicle 10 to communicate with a user. The user interface device 200 may receive user input and may provide information generated by the vehicle 10 to the user. The vehicle 10 may implement a User Interface (UI) or a User Experience (UX) through the user interface device 200.

The object detection device 210 may detect objects present outside the vehicle 10. The object detection device 210 may include at least one of a camera, a radar, a lidar, an ultrasonic sensor, or an infrared sensor. The object detection device 210 may provide data on an object, which is generated based on a sensing signal generated by the sensor, to at least one electronic device included in the vehicle.

The object detection device 210 may generate dynamic data based on the sensing signal with respect to the object. The object detection device 210 may provide the dynamic data to the electronic device 100.

The communicator 220 may exchange signals with devices located outside the vehicle 10. The communicator 220 may exchange signals with at least one of an infrastructure (e.g. a server) or other vehicles. In order to realize communication, the communicator 220 may include at least one of a transmission antenna, a reception antenna, a Radio-Frequency (RF) circuit capable of implementing various communication protocols, or an RF device.

The driving operation device 230 is a device that receives user input for driving the vehicle. In the manual mode, the vehicle 10 may be driven based on a signal provided by the driving operation device 230. The driving operation device 230 may include a steering input device (e.g. a steering wheel), an acceleration input device (e.g. an accelerator pedal), and a brake input device (e.g. a brake pedal).

The main ECU 240 may control the overall operation of at least one electronic device provided in the vehicle 10.

The vehicle driving device 250 is a device that electrically controls the operation of various devices in the vehicle 10. The vehicle driving device 250 may include a powertrain driving unit, a chassis driving unit, a door/window driving unit, a safety device driving unit, a lamp driving unit, and an air-conditioner driving unit. The powertrain driving unit may include a power source driving unit and a transmission driving unit. The chassis driving unit may include a steering driving unit, a brake driving unit, and a suspension driving unit.

The ADAS 260 may generate a signal for controlling the movement of the vehicle 10 or outputting information to the user based on the data on an object received from the object detection device 210. The ADAS 260 may provide the generated signal to at least one of the user interface device 200, the main ECU 240, or the vehicle driving device 250.

The ADAS 260 may implement at least one of Adaptive Cruise Control (ACC), Autonomous Emergency Braking (AEB), Forward Collision Warning (FCW), Lane Keeping Assist (LKA), Lane Change Assist (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM), or Traffic Jam Assist (TJA).

The sensing unit 270 may sense the state of the vehicle. The sensing unit 270 may include at least one of an inertial navigation unit (IMU) sensor, a collision sensor, a wheel sensor, a speed sensor, an inclination sensor, a weight detection sensor, a heading sensor, a position module, a vehicle forward/reverse movement sensor, a battery sensor, a fuel sensor, a tire sensor, a steering sensor for detecting rotation of the steering wheel, a vehicle internal temperature sensor, a vehicle internal humidity sensor, an ultrasonic sensor, an illuminance sensor, an accelerator pedal position sensor, or a brake pedal position sensor. The inertial navigation unit (IMU) sensor may include at least one of an acceleration sensor, a gyro sensor, or a magnetic sensor.

The sensing unit 270 may generate data on the state of the vehicle based on the signal generated by at least one sensor. The sensing unit 270 may acquire sensing signals of vehicle attitude information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle forward/reverse movement information, battery information, fuel information, tire information, vehicle lamp information, vehicle internal temperature information, vehicle internal humidity information, a steering wheel rotation angle, vehicle external illuminance, the pressure applied to the accelerator pedal, the pressure applied to the brake pedal, and so on.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 270 may generate vehicle state information based on the sensing data. The vehicle state information may be generated based on data detected by various sensors included in the vehicle.

For example, the vehicle state information may include vehicle attitude information, vehicle speed information, vehicle inclination information, vehicle weight information, vehicle heading information, vehicle battery information, vehicle fuel information, vehicle tire air pressure information, vehicle steering information, vehicle internal temperature information, vehicle internal humidity information, pedal position information, vehicle engine temperature information, and so on.

The location data generating device 280 may generate data on the location of the vehicle 10. The location data generating device 280 may include at least one of a global positioning system (GPS) or a differential global positioning system (DGPS). The location data generating device 280 may generate data on the location of the vehicle 10 based on the signal generated by at least one of the GPS or the DGPS. In some embodiments, the location data generating device 280 may correct the location data based on at least one of the inertial measurement unit (IMU) of the sensing unit 270 or the camera of the object detection device 210.

The vehicle 10 may include an internal communication system 50. The electronic devices included in the vehicle 10 may exchange signals via the internal communication system 50. The signals may include data. The internal communication system 50 may use at least one communication protocol (e.g. CAN, LIN, FlexRay, MOST, and Ethernet).

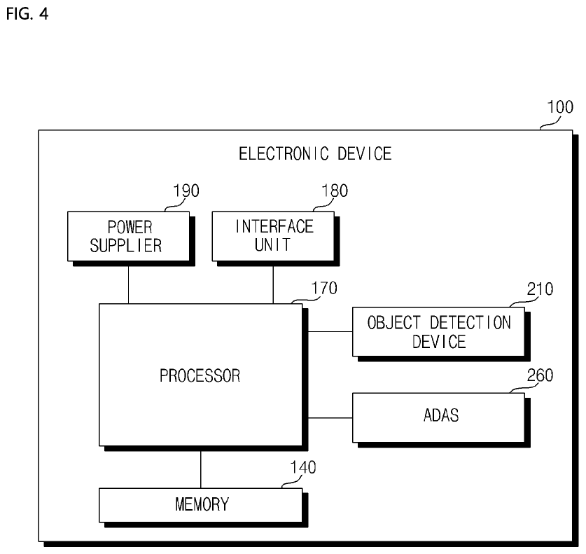

FIG. 4 is a block diagram for explaining the electronic device for a vehicle according to the embodiment of the present disclosure.

Referring to FIG. 4, the electronic device 100 for a vehicle may further include an object detection device 210 and an ADAS 260 in an individual manner or a combined manner, unlike the electronic device for a vehicle described with reference to FIG. 3.

The processor 170 of the vehicle electronic device 100 in FIG. 3 exchanges data with the object detection device 210 and the ADAS 260 through the interface unit 180, whereas the processor 170 of the vehicle electronic device 100 in FIG. 4 may be electrically connected to the object detection device 210 and the ADAS 260 to exchange data with the same. In this case, the object detection device 210 and the ADAS 260 may be electrically connected to the printed circuit board to which the processor 170 is electrically connected.

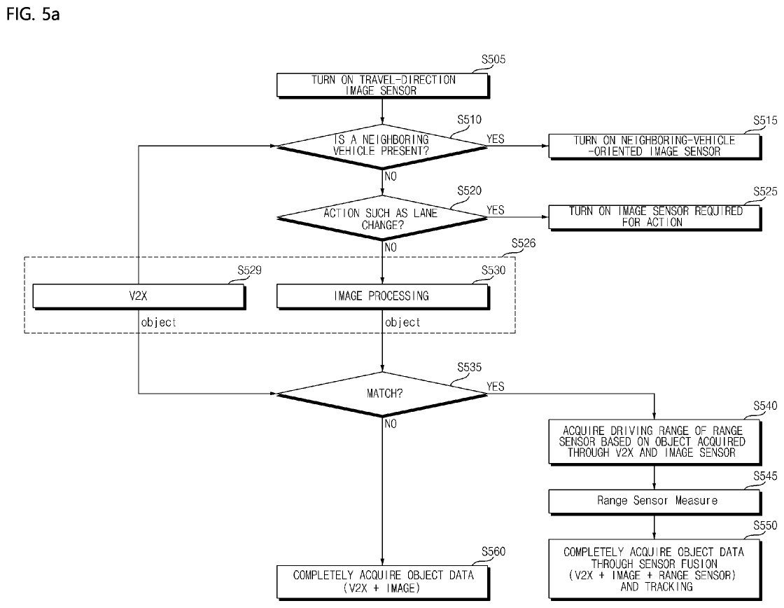

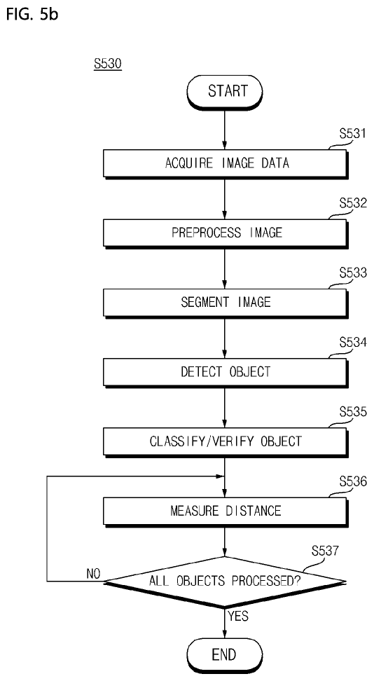

FIG. 5a is a flowchart of the electronic device for a vehicle according to the embodiment of the present disclosure. FIG. 5a is a flowchart of a method of operating the electronic device for a vehicle.

Referring to FIG. 5a, in the state in which the camera oriented in the traveling direction of the vehicle 10 is activated (S505), the processor 170 may determine whether another vehicle is present near the vehicle 10 (S510).

Upon determining that another vehicle is present near the vehicle, the processor 170 may provide a signal for activating a camera oriented in the direction in which the other vehicle is located (S515). The processor 170 may acquire data on objects outside the vehicle 10 from an external device through the V2X communication 220a. The processor 170 may determine whether another vehicle is present near the vehicle 10 based on the data on objects acquired through the V2X communication (S529).

Upon determining that no other vehicle is present near the vehicle, the processor 170 may determine whether the vehicle 10 is to change lanes based on the motion planning data received from the main ECU 240 (S520). Upon determining that the vehicle 10 is to change lanes, the processor 170 may provide a signal for activating a camera oriented toward the lane to which the vehicle is to move (S525).

Upon determining that the vehicle 10 is not to change lanes, the processor 170 may acquire data on objects outside the vehicle 10 in the state in which power is supplied thereto from the power supplier 190 (S526).

The acquiring step (S526) may include a step of receiving, by the at least one processor 170, first data on objects from an external device through the communicator mounted in the vehicle (S529), and a step of receiving, by the at least one processor 170, second data on objects from the camera mounted in the vehicle 10 (S530).

The processor 170 may receive first data on objects from an external device through the communicator 220 mounted in the vehicle 10 (S529). The first data may include information about the presence or absence of the object, information about the location of the object, and information about the type of the object.

The camera may process image data to generate second data on objects (S530). The processor 170 may receive the second data on objects from the camera mounted in the vehicle 10. The second data may include information about the presence or absence of the object, information about the location of the object, information about the type of the object, and information about the distance between the vehicle 10 and the object.

The processor 170 may determine whether the first data and the second data match each other (S535). For example, the processor 170 may determine whether the first data and the second data match each other based on whether the types of the objects match each other. For example, the processor 170 may determine that the first data and the second data match each other when the size of an error between the first data and the second data, each of which indicates the distance between the vehicle 10 and the object, is within a reference range. For example, the processor 170 may determine whether the first data and the second data match each other based on the object location data in the map data.

Upon determining that the first data and the second data match each other, the processor 170 may complete the acquisition of data on objects (S560). The processor 170 may use the data on objects acquired at step S526. Upon determining that the first data and the second data do not match each other, the processor 170 may generate a signal for setting the sensing parameter of at least one range sensor based on the data on objects (S540).

The generating step (S540) may include a step of generating, by the at least one processor 170, a signal for setting at least one of the frame rate or the sensing range of at least one range sensor that is oriented toward the object.

The generating step (S540) may include a step of increasing, by the at least one processor 170, the frame rate of at least one range sensor based on the data on objects. The processor 170 may generate a signal for setting the frame rate of at least one range sensor that is oriented toward the object. For example, the processor 170 may increase the frame rate based on the data on objects. More accurate data on the objects may be generated by increasing the frame rate. For example, the processor 170 may generate a signal for increasing the frame rate of a signal (e.g. electromagnetic radiation, laser radiation, ultrasonic radiation, infrared radiation, etc.) emitted from at least one range sensor toward objects based on the data on objects.

The generating step (S540) may include a step of determining, by the at least one processor 170, a data processing region in a field of view (FOV) of at least one range sensor that is oriented toward the object based on data on the object in the state in which power is supplied to the processor 170. The step of determining the data processing region may include a step of determining, by the at least one processor 170, a first region, in which the probability that the object is located is equal to or greater than a predetermined value, based on the first data, and a step of determining, by the at least one processor 170, the first region to be a data processing region. The step of determining the data processing region may include a step of determining, by the at least one processor 170, a second region, in which the probability that the object is located is equal to or greater than a predetermined value, based on the second data, and a step of determining the second region to be a data processing region. When it is determined that the first data and the second data do not match each other, the determining step may include a step of determining, by the at least one processor 170, determining a region that includes both the first region and the second region to be a data processing region. The generating step (S540) may include a step of increasing or changing, by the at least one processor 170, the sensing range of the at least one range sensor based on the data on objects. The processor 170 may provide a signal for setting the sensing range of at least one range sensor that is oriented toward objects. For example, the processor 170 may increase the sensing range based on data on objects. More accurate data on the objects may be generated by increasing the sensing range. For example, the processor 170 may generate a signal for increasing the sensing range of a signal (e.g. electromagnetic radiation, laser radiation, ultrasonic radiation, infrared radiation, etc.) emitted from at least one range sensor toward objects based on data on objects. For example, the processor 170 may generate a signal for changing the sensing range of a signal (e.g. electromagnetic radiation, laser radiation, ultrasonic radiation, infrared radiation, etc.) emitted from at least one range sensor toward objects based on data on objects.

The processor 170 may provide the generated signal to the object detection device 210. The object detection device 210 may control at least one range sensor based on the signal received from the electronic device 100.

The processor 170 may acquire third data on objects, which is generated based on the set sensing parameter, from the range sensor (S545).

The processor 170 may generate fusion data based on the first data on the object acquired from the communicator 220, the second data on the object acquired from the camera, and the third data acquired from the range sensor (S550).

In some embodiments, the method of operating the electronic device for a vehicle may further include a step of acquiring, by at least one processor, motion planning information of the vehicle 10. In this case, the determining step may include a step of determining, by the at least one processor, a data processing region based further on the motion planning data.

FIG. 5b is a flowchart of a detailed algorithm of step S530 in FIG. 5a.

Referring to FIG. 5b, the processor 170 may acquire image data from the camera mounted in the vehicle 10 (S531).

The processor 170 may perform preprocessing on the acquired image (S532). Specifically, the processor 170 may perform noise reduction, rectification, calibration, color enhancement, color space conversion (CSC), interpolation, camera gain control, and the like with respect to the image. Therefore, it is possible to acquire an image that is clearer than the stereo image captured by the camera 195.

The processor 170 may perform segmentation with respect to the image that has been preprocessed (S533). For example, the processor 170 may divide the preprocessed image into a background and a foreground.

For example, the processor 170 may determine a region unrelated to travel of the vehicle to be the background, and may exclude the corresponding part. Thereby, the foreground may be roughly isolated.

For example, the processor 170 may divide the preprocessed image into a plurality of segments based on homogeneous pixels having similar colors.

The processor 170 may detect an object based on the segmented images (S534).

The processor 170 may detect an object in at least one of the images. For example, the processor 170 may detect an object based on the recognized characteristic point. For example, the processor 170 may detect an object from the foreground separated by the image segment. For example, the processor 170 may recognize a region, which is divided into at least one segment, as an object. In some embodiments, the processor 170 may divide an object colored with two colors into two segments, but may recognize the same as a single object.

The processor 170 may classify and verify the object (S535). To this end, the processor 170 may use, for example, an identification method using a neural network, a Support Vector Machine (SVM) method, an AdaBoost identification method using a Haar-like feature, or a Histograms of Oriented Gradients (HOG) method.

The processor 170 may verify the object by comparing the detected object with the objects stored in the memory 140. For example, the processor 170 may verify lanes OB10, another vehicle OB11, a pedestrian OB12, a 2-wheeled vehicle OB13, traffic signals OB14 and OB15, a light, a road, a structure, a speed bump, a geographic feature, an animal, and so on.

The processor 170 may measure the distance to the verified object (S536). For example, when the image acquired at step S531 is a stereo image, the distance to the object may be measured based on the disparity data. For example, the processor 170 may measure the distance to the object based on variation in the size of the object acquired during the movement of the vehicle 10. For example, the processor 170 may measure the distance to the object based on the pixels occupied by the object in the image.

When the object is completely processed (S537), the image processing step is terminated. When the object is not completely processed (S537), step S536 may be repeatedly performed.

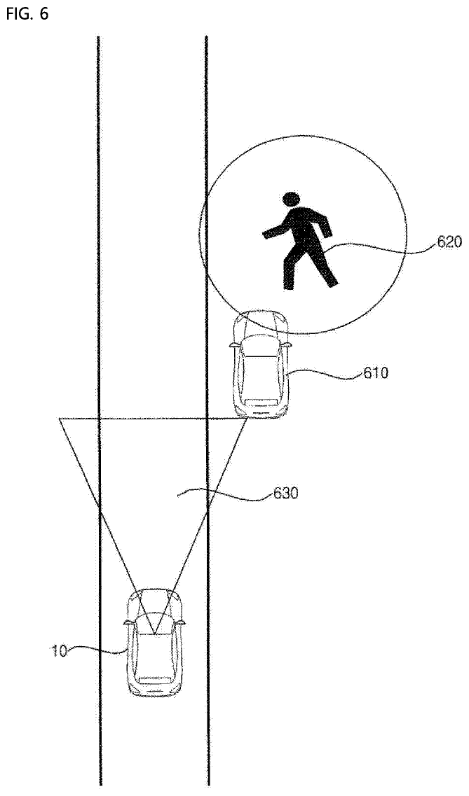

FIG. 6 is a view for explaining the operation of the electronic device for a vehicle according to the embodiment of the present disclosure.

Referring to FIG. 6, the processor 170 may acquire data on objects 610 and 620 outside the vehicle 10 in the state in which power is supplied thereto. The objects 610 and 620 may include at least one of another vehicle 610 or a pedestrian 620.

The processor 170 may receive first data on the objects from the communicator 220. The first data on the objects may be data that the communicator 220 acquires through V2X communication. The communicator 220 may receive the first data by directly or indirectly receiving a signal generated by a V2X communicator in another vehicle 610. The communicator 220 may receive the first data by directly or indirectly receiving a signal generated by the mobile terminal carried by the pedestrian 620.

The processor 170 may acquire motion planning data of the vehicle 10 from at least one of the vehicle driving device 250, the main ECU 240, or the ADAS 265 through the interface unit 180.

The processor 170 may generate a signal for setting the frame rate of the camera, which captures an image of the pedestrian 620, based on the data on the pedestrian 620. For example, when the processor 170 acquires data on the pedestrian 620 through the communicator 220, the processor 170 may generate a signal for setting the frame rate of the camera to be higher than in a general situation. The accuracy of the pedestrian detection algorithm may be improved by increasing the frame rate.

The processor 170 may generate a signal for setting the sensing parameter of the at least one range sensor that is oriented toward the pedestrian 620. The processor 170 may receive data on the objects of the at least one range sensor, which is acquired by the set parameter.

The processor 170 may combine two or more of the data on the objects acquired by the communicator 220, the data on the objects acquired by the camera, and the data on the objects acquired by the range sensor.

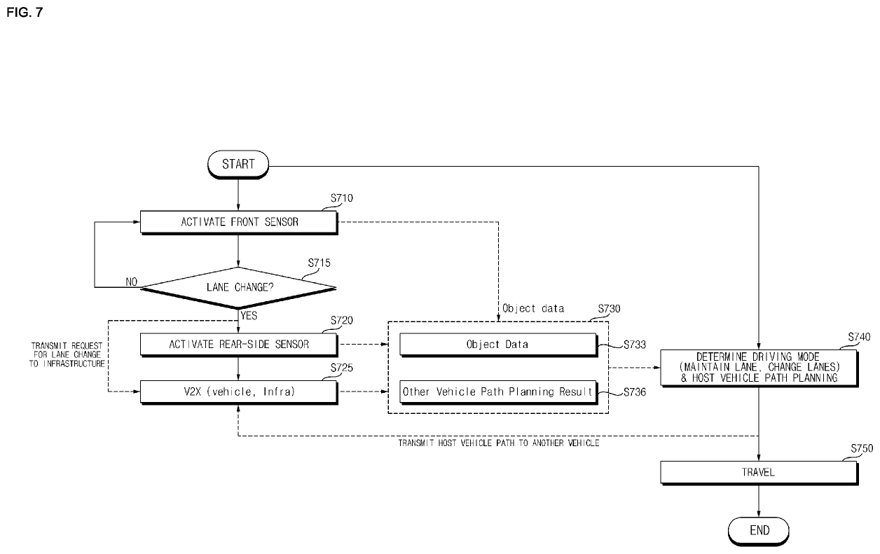

FIG. 7 is a flowchart of the electronic device for a vehicle according to the embodiment of the present disclosure.

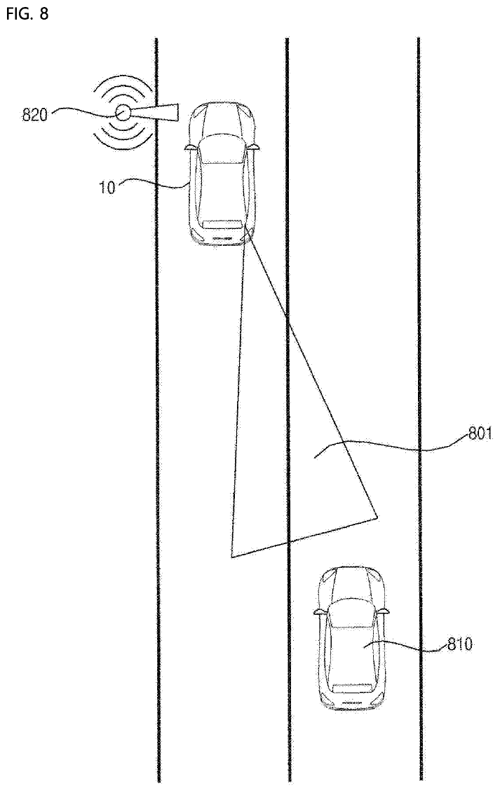

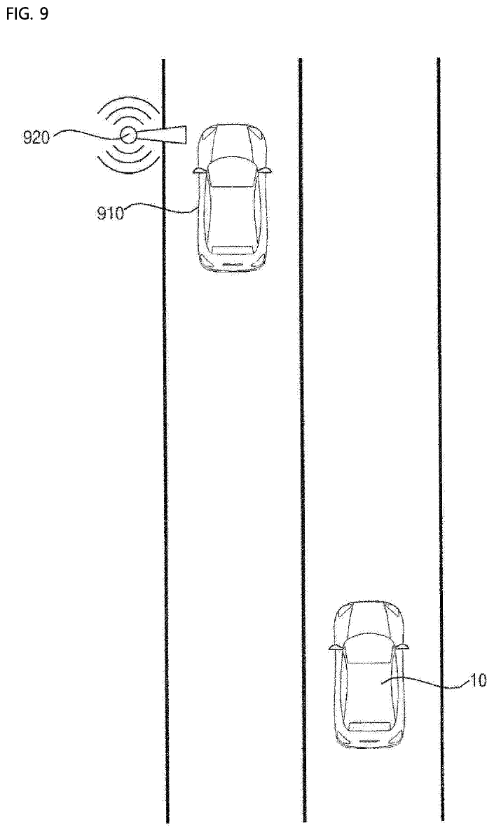

FIGS. 8 and 9 are views for explaining the operation of the electronic device for a vehicle according to the embodiment of the present disclosure.

Referring to FIGS. 7 to 9, the processor 170 may activate the front sensor (S710). The front sensor is used to detect an object located ahead of the vehicle 10, and may include at least one of a camera, a radar, a lidar, an ultrasonic sensor, or an infrared sensor.

The processor 170 may acquire motion planning data of the vehicle 10. The processor 170 may determine whether the vehicle 10 is to change lanes based on the acquired motion planning data (S715).

Upon determining that the vehicle is to change lanes, the processor 170 may activate the rear-side sensor 801 (S720). The rear-side sensor is used to detect an object 810 located in a posterolateral area of the vehicle 10, and may include at least one of a camera, a radar, a lidar, an ultrasonic sensor, or an infrared sensor. For example, when the vehicle 10 is to change lanes from the traveling lane to the left lane, the processor 170 may activate the rear-left sensor. For example, when the vehicle 10 is to change lanes from the traveling lane to the right lane, the processor 170 may activate the rear-right sensor.

The processor 170 may transmit a lane change request signal to another vehicle and the server through the interface unit 180 and the communicator 220 using V2X communication (S725). The communicator 220 may transmit a lane change request signal to at least one of another vehicle 810 or the server via an RSU 820.

The processor 170 may acquire data on the object (S730). The processor 170 may acquire data on the object based on the sensing data generated by the rear-side sensor (S733). The processor 170 may acquire motion planning data of another vehicle through the communicator 220 using V2X communication (S736). The motion planning data may be referred to as path planning data. The communicator 220 may receive motion planning data of another vehicle from at least one of the other vehicle 810 or the server via the RSU 820. The communicator 220 may provide the received motion planning data of the other vehicle to the electronic device 100.

The processor 170 may determine the driving situation of the vehicle 10, and may plan a path of the vehicle 10 (S740). The processor 170 may determine whether to remain in the traveling lane or whether to change lanes based on the data on the object acquired at step S730. The processor 170 may plan the path of the vehicle 10 based on the determination on whether to remain in the traveling lane or whether to change lanes. For example, when the vehicle 10 is to change lanes, upon determining that there is no interference with the path of another vehicle in the lane to which the vehicle 10 is to move, the processor 170 may provide a control signal so that the vehicle 10 changes lanes. When the vehicle 10 is to change lanes, upon determining that there is interference with the path of another vehicle in the lane to which the vehicle 10 is to move, the processor 170 may generate path planning data again based on the motion planning data of the other vehicle 810.

The processor 170 may provide path planning data to at least one of the main ECU 240, the vehicle driving device 250, or the ADAS 260 through the interface unit 180. The vehicle 10 may travel based on the path planning data (S750).

The server may receive a lane change request signal from the vehicle 10, and may determine whether it is possible for the vehicle 10 to change lanes. Upon determining that it is safe for the vehicle 10 to change lanes, the server may transmit a lane change permission signal to the vehicle 10. The server may provide a signal requesting speed adjustment to another vehicle that is traveling in the lane to which the vehicle 10 is to move. The vehicle 10 may change lanes.

The processor 170 may activate only the front sensor in the state in which a Lane Keeping Assist System (LKAS) mode is activated. When the vehicle 10 is to change lanes, the processor 170 may transmit the motion planning data to at least one of another vehicle or the server through the communicator 220 using V2X communication. The processor 170 may receive a lane change permission signal through the communicator 220. In this case, the processor 170 may activate the rear-side sensor that is oriented toward the lane to which the vehicle is to move.

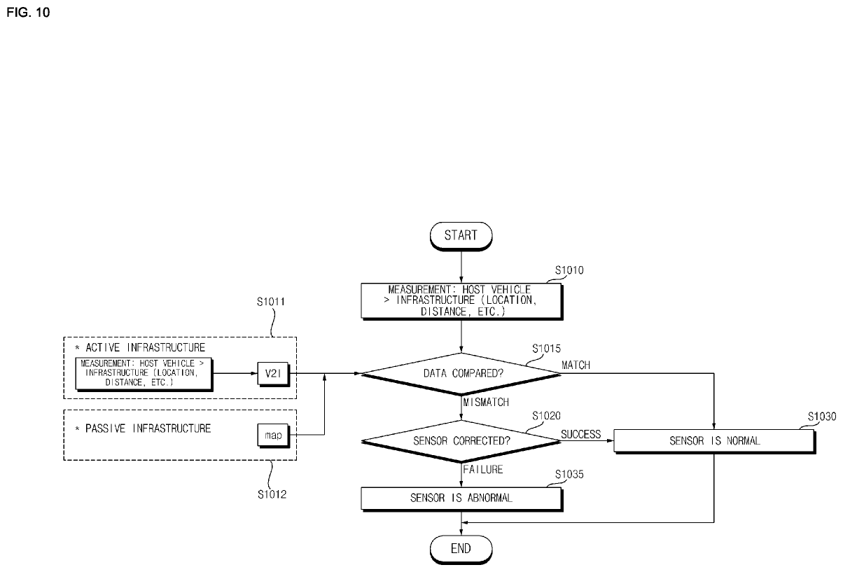

FIG. 10 is a flowchart of the electronic device for a vehicle according to the embodiment of the present disclosure.

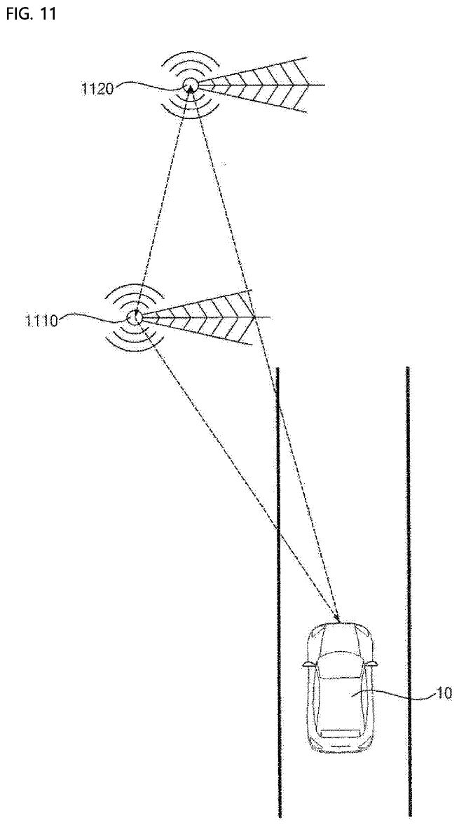

FIG. 11 is a view for explaining the operation of the electronic device for a vehicle according to the embodiment of the present disclosure.

Referring to FIGS. 10 and 11, the processor 170 may acquire location data of the vehicle 10 from the location data generating device 280. The processor 170 may generate data on a first relationship between the vehicle 10 and the RSUs 1110 and 1120 (S1010). The data on the first relationship between the vehicle 10 and the RSUs 1110 and 1120 may include at least one of absolute location data of each of the vehicle 10 and the RSUs 1110 and 1120, relative location data thereof, or distance data thereof.

The server may generate data on a second relationship between the RSUs 1110 and 1120 and the vehicle 10 (active infrastructure) (S1011). The second relationship data may include at least one of absolute location data of each of the vehicle 10 and the RSUs 1110 and 1120, relative location data thereof, or distance data thereof.

In some embodiments, the server may generate second relationship data based on the absolute locations of the RSUs 1110 and 1120 and the location of the vehicle 10 in the map (passive infrastructure) (S1012).

The processor 170 may receive the second relationship data from the server.

The processor 170 may compare the first relationship data and the second relationship data with each other (S1015).

Upon determining that the first relationship data and the second relationship data match each other, the processor 170 may determine that at least one sensor included in the object detection device 210 is normal (S1030).

Upon determining that the first relationship data and the second relationship data do not match each other, the processor 170 may correct the sensor data based on the second relationship data. The processor 170 may correct the sensing data generated by the object detection device 210 based on the second relationship data.

The processor 170 may determine whether the sensor is successfully corrected (S1020). Upon determining that the sensor is successfully corrected, the processor 170 may determine that at least one sensor included in the object detection device 210 is normal (S1030). Upon determining that the sensor is not successfully corrected, the processor 170 may determine that at least one sensor included in the object detection device 210 is abnormal (S1035).

The aforementioned present disclosure may be implemented as computer-readable code stored on a computer-readable recording medium. The computer-readable recording medium may be any type of recording device in which data is stored in a computer-readable manner. Examples of the computer-readable recording medium include a Hard Disk Drive (HDD), a Solid-State Disk (SSD), a Silicon Disk Drive (SDD), Read-Only Memory (ROM), Random-Access Memory (RAM), CD-ROM, magnetic tapes, floppy disks, optical data storage devices, carrier waves (e.g. transmission via the Internet), etc. In addition, the computer may include a processor and a controller. The above embodiments are therefore to be construed in all aspects as illustrative and not restrictive. It is intended that the present disclosure cover the modifications and variations of this disclosure provided they come within the scope of the appended claims and their equivalents.

### DESCRIPTION OF REFERENCE NUMERALS

100: electronic device for vehicle

1. An electronic device for a vehicle, comprising:
a power supplier; and
a processor configured to:
acquire data on an object outside a vehicle in a state in which the power is supplied thereto, and
determine a data processing region in a field of view (FOV) of at least one range sensor oriented toward the object based on the data on the object.

2. The electronic device of claim 1, wherein the processor is configured to:
receive first data on the object from an external device through a communicator mounted in the vehicle,
determine a first region, in which a probability that the object is located is equal to or greater than a predetermined value, based on the first data, and
determine the first region to be the data processing region.

3. The electronic device of claim 2, wherein the processor is configured to:
receive second data on the object from a camera mounted in the vehicle,
determine a second region, in which a probability that the object is located is equal to or greater than a predetermined value, based on the second data, and
determine the second region to be the data processing region.

4. The electronic device of claim 3, wherein the processor is configured to, upon determining that the first data and the second data do not match each other, determine a region in which the first region and the second region are included to be the data processing region.

5. The electronic device of claim 1, wherein the processor is configured to acquire motion planning data of the vehicle and determine the data processing region based further on the motion planning data.

6. A method of operating an electronic device for a vehicle, the method comprising:
acquiring, by at least one processor, data on an object outside a vehicle in a state in which power is supplied to the at least one processor; and
determining, by the at least one processor, a data processing region in a field of view (FOV) of at least one range sensor oriented toward the object based on the data on the object in a state in which power is supplied to the at least one processor.

7. The method of claim 6, wherein the acquiring comprises:
receiving, by the at least one processor, first data on the object from an external device through a communicator mounted in the vehicle, and
wherein the determining comprises:
determining a first region, in which a probability that the object is located is equal to or greater than a predetermined value, based on the first data; and
determining the first region to be the data processing region.

8. The method of claim 6, wherein the acquiring comprises:
receiving, by the at least one processor, second data on the object from a camera mounted in the vehicle, and
wherein the determining comprises:
determining, by the at least one processor, a second region, in which a probability that the object is located is equal to or greater than a predetermined value, based on the second data; and
determining, by the at least one processor, the second region to be the data processing region.

9. The method of claim 7, further comprising:
determining, by the at least one processor, whether the first data and the second data match each other,
wherein the determining comprises, upon determining that the first data and the second data do not match each other, determining, by the at least one processor, a region in which the first region and the second region are included to be the data processing region.

10. The method of claim 7, further comprising:
acquiring, by the at least one processor, motion planning information of the vehicle,
wherein the determining comprises determining, by the at least one processor, the data processing region based further on the motion planning data.
